(19) United States
(12) Patent Application Publication
(10) Pub. No.: US 2024/0316924 A1
(43) Pub. Date: Sep. 26, 2024

(54) LIQUID EJECTING HEAD

(71) Applicant: BROTHER KOGYO KABUSHIKI KAISHA, Nagoya (JP)

(72) Inventor: SHOTARO KANZAKI, Handa (JP)

(73) Assignee: BROTHER KOGYO KABUSHIKI KAISHA, Nagoya (JP)

(21) Appl. No.: 18/543,230

(22) Filed: Dec. 18, 2023

(30) Foreign Application Priority Data
Mar. 20, 2023 (JP) 2023-044400

(51) Int. Cl. B41J 2/14

(52) U.S. Cl. CPC B41J 2/14201; B41J 2002/14419

(57) ABSTRACT

There is provided a liquid ejecting head including a stacked body in which plates including a return throttle plate and at least one return manifold plate are stacked. The stacked body is formed with, in the inside thereof: individual channels, a supply manifold, and a return manifold. A supply throttle channel is formed in an upstream end of each of the individual channels, and a return throttle channel is formed in a downstream end of each of the individual channels. A through groove constructing the return throttle channel is formed in the return throttle plate, and a through port constructing the return manifold is formed in the at least one return manifold plate. The return throttle plate and the at least one return manifold plate are adhered directly to each other so as to allow the through groove and the through port to communicate with each other.

### REFERENCE TO RELATED APPLICATIONS

This application claims priority from Japanese Patent Application No. 2023-044400 filed on Mar. 20, 2023. The entire content of the priority application is incorporated herein by reference.

### BACKGROUND ART

There is a known liquid ejecting head provided with a configuration of circulating a liquid in the inside thereof. For example, a known liquid ejecting head includes a channel including a supply manifold, a supply throttle channel, a nozzle, a return throttle channel, and a return manifold, as the configuration for circulating the liquid. Among the above-described parts or components of the channel, the cross-sectional area of each of the supply throttle channel and the return throttle channel is smaller than the cross-sectional areas of other parts of the channel, and each of the supply throttle channel and the return throttle channel has a higher resistance than those of the other parts of the channel. Accordingly, by appropriately set the resistance, it is possible to allow the liquid in the vicinity of the nozzle to have a desired pressure and to realize a stable ejection of the liquid.

### SUMMARY

There is such a case, however, that each of the supply throttle channel and the return throttle channel is formed by a bottomed groove which is formed in a plate, in some cases. Generally, in a case of a liquid ejecting head constructed of a stacked body of a plurality of plates, the etching is used for the formation of a groove in each of the plates. Further, the half-etching is used for the formation of a bottomed groove such as the supply throttle channel and the return throttle channel. The half-etching, however, might be a cause of any error in a width direction and a depth direction of the groove due to any deviation or fluctuation in an etching condition. Accordingly, there is such a possibility that the resistance in each of the supply throttle channel and the return throttle channel might greatly differ from a set value.

Further, it is also possible to form the supply throttle channel by the half-etching and to form the return throttle channel by a full-etching so as to penetrate through the plate. In this case, there is such a possibility that the above-described problem might occur with respect to the supply throttle channel. On the other hand, although the return throttle channel is formed by the full etching so as to penetrate through the plate; in this case, however, one plate is intervened between the return throttle channel and the return manifold, in some cases, so as to cover a surface in which the return throttle channel is opened. In this case, the manufacturing cost of the liquid ejecting head becomes high.

In view of the above-described situation, an object of the present disclosure is to provide a liquid ejecting head capable of suppressing any deviation, with respect to the resistance of the supply throttle channel and the return throttle channel, from a set value and of reducing the number of the plates used to thereby suppress any increase in the manufacturing cost.

According to an aspect of the present disclosure, there is provided a liquid ejecting head including a stacked body in which a plurality of plates is stacked, the plurality of plates including a return throttle plate and at least one return manifold plate. The stacked body includes: a plurality of individual channels each of which includes a nozzle; a supply manifold which is configured to supply a liquid to the plurality of individual channels; and a return manifold configured to allow the liquid which has not been ejected from the nozzle to be returned to the return manifold from the plurality of individual channels. A supply throttle channel connectable to the supply manifold is located in an upstream end of each of the plurality of individual channels, and a return throttle channel connectable to the return manifold is located in a downstream end of each of the plurality of individual channels. A through groove constructing the return throttle channel is formed in the return throttle plate, and a through port constructing the return manifold is formed in the at least one return manifold plate. The return throttle plate and the at least one return manifold plate are adhered directly to each other so as to allow the through groove and the through port to communicate with each other.

According to the present disclosure, since the return throttle channel is formed as the through groove by, for example, the full etching, at least any measuring error (dimension error) in the depth direction does not occur, thereby making it possible to suppress any occurrence of an error in the circulating resistance with respect to the set value. Further, since the return throttle plate and the return manifold plate are directly adhered to each other, there is no any other plate intervened between the return throttle channel and the return manifold, thereby making it possible to reduce the number of the plates and to suppress the increase in the manufacturing cost.

### BRIEF DESCRIPTION OF DRAWINGS

FIG. 1 is a plan view schematically depicting the configuration of a liquid ejecting apparatus provided with a liquid ejecting head according to the present disclosure.

FIG. 2 is a cross-sectional view of the liquid ejecting head.

FIG. 3 is a schematic view for explaining a detailed configuration of a return throttle channel.

FIG. 4 is a view for explaining a modification of the return throttle channel.

### DESCRIPTION

In the following, an embodiment according to the present disclosure will be specifically explained, with reference to the drawings. Note that in the following description, same reference numerals are affixed to same or corresponding elements throughout all the drawings, and any overlapping explanation therefor will be omitted. Further, the present disclosure is not limited to or restricted by the following embodiment, and any addition, deletion and/or change is/are possible within a range not departing from the spirit of the present disclosure.

### Configuration of Liquid Ejecting Apparatus

A liquid ejecting apparatus 1 is configured to eject a liquid such as, for example, an ink, etc., from a liquid ejecting head 10 onto a recording medium so as to form (print) a letter, an image, etc., on the recording medium. In the following, although an explanation will be given about a case in which such a liquid ejecting apparatus 1 is exemplified by an ink-jet printer, an aspect which can be realized by the liquid ejecting head 1 is not limited to this.

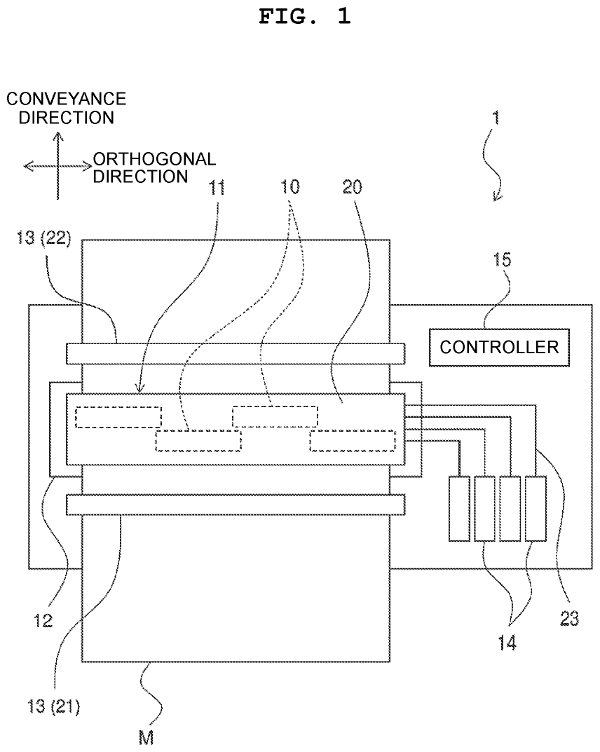

As depicted in FIG. 1, the liquid ejecting head 1 adopts a line head system, and is configured to discharge an ink, from a head unit 11 provided in a fixed manner thereto, onto a recording medium M such as a paper sheet (sheet, paper), etc., which is being conveyed in a conveyance direction. Such a liquid ejecting head 1 is also provided with a platen 12, a conveyor 13, a plurality of tanks 14 and a controller 15, in addition to the head unit 11. Note that the liquid ejecting head 1 may adopt a serial head system, rather than the line head system.

The head unit 11 has a head holder 20 of which size is long in an orthogonal direction orthogonal to the conveyance direction; a plurality of the liquid ejecting heads 10 is mounted on the head holder 20. For example, the plurality of liquid ejecting heads 10 is arranged in the orthogonal direction while being shifted, one by one, to an upstream side and a downstream side in the conveyance direction; in other words, the plurality of liquid ejecting heads 10 is arranged in a so-called staggered manner.

The platen 12 is, for example, a member which has shape of a flat and rectangular plate, and is opposite to the head unit 11. Further, the platen 12 has a size in the orthogonal direction longer than that of the head unit 11; a landing area of the ink discharged from the head unit 11 is positioned within an upper surface-area of the upper surface of the platen 12. The platen 12 supports the recording medium M, which is being conveyed along a predetermined conveyance direction, on the upper surface of the platen 12. With this, a distance between the head unit 11 and the recording medium M is defined.

The conveyor 13 has two conveying roller pairs 21 and 22 and a conveying motor. The conveying roller pair 21 as one of the two conveying pairs is located on the upstream side in the conveyance direction with respect to the platen 12, and is constructed of a driving roller and a driven roller forming a pair in an up-down direction. The driving roller is driven by the conveying motor, pinches or holds the recording medium M between the driving roller and the driven roller, and conveys the recording medium M to the downstream side in the conveyance direction, toward and onto the platen 12. The conveying roller pair 22 as the other of the two conveying pairs is located on the downstream side in the conveyance direction with respect to the platen 12, and is constructed of a driving roller and a driven roller forming a pair in the up-down direction. The driving roller is driven by the conveying motor, pinches or holds the recording medium M between the driving roller and the driven roller, and conveys the recording medium M from the upper surface of the platen 12 to the downstream side in the conveyance direction.

The number the plurality of tanks 14 is the number corresponding to a kind of the ink. For example, in a case that the liquid ejecting apparatus 1 is a printer configured to form a color image, a total of not less than four tanks storing, respectively, inks of respective colors which are cyan, magenta, yellow and black inks, are provided on the liquid ejecting apparatus 1. Each of the tanks 14 is connected to the head unit 11 via a supply tube 23, and the ink is fed from each of the tank 14 to the liquid ejecting head 10 via the supply tube 23.

The controller 15 controls the operation of a driving element of each of the respective parts provided on the liquid ejecting apparatus 1. For example, in a case that the controller 15 receives an executing instruction of a print job from the outside (an external apparatus or device), the controller 15 controls the conveyor 13 so as to convey the recording medium M on the platen 12. In a case that the recording medium M reaches a predetermined position on the platen 12, the controller 15 controls the liquid ejecting head(s)10 to discharge the ink(s) based on image data in the print job, thereby forming an image on the recording medium M. the controller 15 controls the conveyor 13 to convey the recording medium M having the image formed thereon, and to discharge the recording medium M from the liquid ejecting apparatus 1.

### Configuration of Liquid Ejecting Head

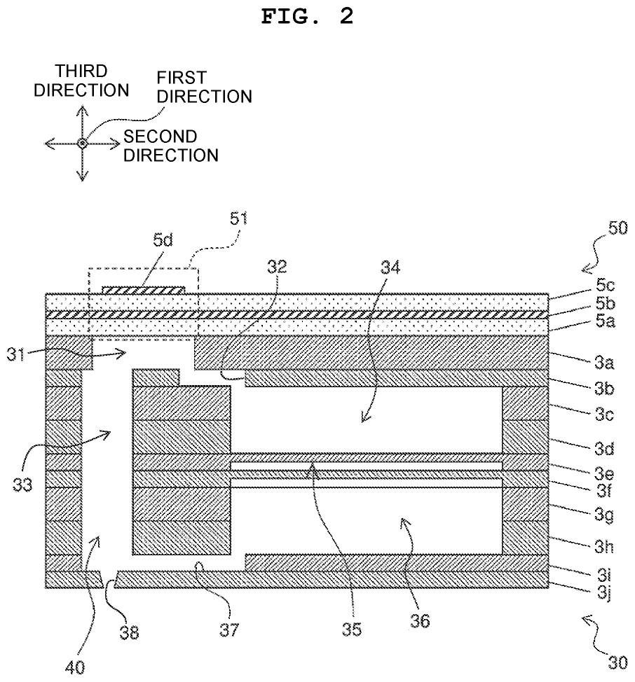

As depicted in FIG. 2, The liquid ejecting head 10 has a channel part 30 and a driving part 50 stacked on the channel part 30. As will be explained in the following, a supply manifold 34 and a return manifold 36 which are long sized are formed in the channel part 30, and an individual channel 40 connects the supply manifold 34 and the return manifold 36 with each other. Note that in the following explanation, a direction in which each of the supply manifold 34 and the return manifold 36 extends is referred to as a first direction. Further, a direction orthogonal to the first direction is referred to as a second direction, and a direction orthogonal to both of the first and second directions is referred to as a third direction; the third direction is coincident to a stacking direction of the channel part 30 and the driving part 50. Further, in the third direction, a direction in which the driving part 50 is positioned with respect to the channel part 30 is referred to as an up direction (upward, upper side) and a direction opposite to the up direction is referred to as the down direction (downward, lower side).

The channel part 30 constructs a stacked body in which a plurality of plates 3a to 3j is stacked, in the third direction, in this order from the upper side to the lower side. The third direction corresponds to a thickness direction of the plurality of plates 3a to 3j. Among the plurality of plates 3a to 3j, the plate 3a constructs a pressure chamber plate which is connected to the lower surface of the driving part 50, and a through port forming a pressure chamber 31 is formed in the plate 3a. This through port is formed by a full etching of performing the etching with respect to the plate 3a from the up-down direction.

The plate 3b constructs a supply throttle plate, and a through groove forming a supply throttle channel 32 is formed in the plate 3b. Further, a through hole forming a descender 33 is also formed in the plate 3b. These through groove and through hole are formed by the full etching of performing the etching with respect to the plate 3b from the up-down direction.

The plates 3c and 3d construct a supply manifold plate, and a through port forming the supply manifold 34 is formed in each of the plates 3c and 3d. This through port constructs an opening having a long-size in the first direction. Further, a through hole forming the descender 33 is also formed in each of the plates 3c and 3d. These through ports and through holes are formed by the full etching of performing the etching with respect to the plates 3c and 3d from the up-down direction.

The plates 3e and 3f construct a damper plate. In the plate 3e, a part, of the plate 3e, corresponding to the supply manifold 34 as seen from the third direction is subjected, at the side of the lower surface thereof, by the half-etching so that the part is made to be a thin part of which thickness size is smaller and of which flexibility is higher than those of another part, of the plate 3e, different from the part. Further, a part, of the plate 3f, corresponding to the return manifold 36 (to be described later on) as seen from the third direction is subjected, at the side of the lower surface thereof, by the half-etching so that the part is made to be a thin part of which thickness size is smaller and of which flexibility is higher than those of another part, of the plate 3f different from the part. Note that a space between the thin part of the plate 3e and the thin part of the plate 3f construct a damper space 35. Further, a through hole forming the descender 33 is also formed in each of the plates 3e and 3f. These through holes are formed, respectively, in the plates 3e and 3f, by performing the full etching with respect to the plates 3e and 3f from the up-down direction. On the other hand, the thin part is formed by the half-etching of performing the etching with respect to each of the plates 3e and 3f from the lower side up to an intermediate part of each of the plates 3e and 3f (so as not to penetrate through each of the plates 3e and 3f).

The plates 3g and 3h construct a return manifold plate, and a through port forming the return manifold 36 is formed in each of the plates 3g and 3h. This through port constructs an opening having a long-size in the first direction, similarly to the through port forming the supply manifold 34. Further, a through hole forming the descender 33 is also formed in each of the plates 3g and 3h. These through ports and through holes are formed by the full etching of performing the etching with respect to the plates 3g and 3h from the up-down direction.

The plate 3i constructs a return throttle plate, and a through groove forming the return throttle channel 37 is formed in the plate 3i. Further, a through hole forming the descender 33 is also formed in the plate 3i. These through groove and through hole are formed by the full etching of performing the etching with respect to the plate 3i from the up-down direction.

The plate 3j constructs a nozzle plate, and a through hole forming a nozzle 38 is formed in the plate 3j. This through hole is formed by the full etching of performing the etching with respect to the plate 3j from the upper side toward the lower side.

The channel part 30 is constructed by stacking the above-described plates 3a to 3j on one another. Namely, plates, of the plates 3a to 3j, which are adjacent to each other are directly connected to each other by an adhesive. For example, the lower surface of the plate 3b (the supply throttle plate) and the upper surface of the plate 3c (constructing the supply manifold plate on the upper side thereof) are directly adhered to each other via the adhesive. With this, the through groove constructing the supply throttle channel 32 and the through port forming the supply manifold 34 communicate with each other. Similarly, the lower surface of the plate 3h (constructing the return manifold plate on the lower side thereof) and the upper surface of the plate 3i (the return throttle plate) are directly adhered to each other via the adhesive. With this, the through groove constructing the return throttle channel 37 and the through port forming the return manifold 36 communicate with each other.

The supply manifold 34, the return manifold 36 and the individual channel 40 are formed in the inside of the stacked body constructing the channel part 30. The individual channel 40 has, along a direction in which the ink flows, partial channels each of which is one of the supply throttle channel 32, the pressure chamber 31, the descender 33, the nozzle 38 and the return throttle channel 37, and links or connects the supply manifold 34 and the return manifold 36 with each other.

Namely, an upstream end of the supply throttle channel 32 is connected to the supply manifold 34, and a downstream end of the supply throttle channel 32 is connected to an upstream end of the pressure chamber 31. A downstream end of the pressure chamber 31 is connected to an upstream end of the descender 33 which extends in the third direction, and a downstream end of the descender 33 is connected to the nozzle 38 and also to an upstream end of the return throttle channel 37. Further, a downstream end of the return throttle channel 37 is connected to the return manifold 36. Furthermore, the ink inside the supply manifold 34 is supplied from the supply throttle channel 32 to the individual channel 40; the ink inside the individual channel 40 is discharged from the nozzle 38. Moreover, the ink which has not been discharged from the nozzle 38 is returned to the return manifold 36 from the return throttle channel 37.

Note that the individual channel 40 is provided as a plurality of individual channels 40 with respect to the supply manifold 34 and the return manifold 36. Further, the nozzles 38 each of which is possessed by one of the plurality of individual channels 40 are arranged as an array along the first direction in which the supply manifold 34 and the return manifold 36 extend, thereby forming a nozzle array. In the present embodiment, the first direction in which the nozzle array extends is coincident with the orthogonal direction in FIG. 1.

Further, the material and thickness size of each of the plates 3a to 3j as described above are not particularly limited. For example, in the present embodiment, it is allowable to use, as the material of each of the plates 3a to 3j, a material in which an opening and/or a recessed part is (are) formable by a wet etching, such as an aluminum alloy, stainless steel, etc. Furthermore, the thickness size can also be set as appropriate; for example, at least one of the plate 3b constructing the supply throttle plate and the plate 3i constructing the return throttle plate may have a thickness of not more than 50 um. With respect to another or other plates which is or are different from the plate 3b and plate 3i, it is also possible to select the size thereof as appropriate while considering the rigidity which is required, the volume of an opening or a recess which is to be formed, etc.

On the other hand, the driving part 50 is an actuator configured to apply, to the ink inside the pressure chamber 31 of the channel part 30, a discharging pressure for discharging the ink from the nozzle 38. As depicted in FIG. 2, the driving part 50 has a configuration wherein a piezoelectric ceramic layer 5a, a common electrode 5b, a piezoelectric ceramic layer 5c and an individual electrode 5d are stacked in this order from the lower side to the upper side of the third direction. The piezoelectric layer 5a which is the lowermost in the above-described configuration is connected to the upper surface of the plate 3a of the channel part 30. Each of the piezoelectric ceramic layer 5a, the common electrode 5b, the piezoelectric ceramic layer 5c has an area covering the entirety of a range including all the pressure chambers 31 in the upper surface of the channel part 30. On the other hand, the individual electrode 5d is provided on each of the plurality of individual channels 40; more specifically, the individual electrode 5d is arranged at a position corresponding to the pressure chamber 31 constructing each of the plurality of individual channels 40.

In such a driving part 50, parts, of the driving part 50, each of which is positioned above one of the pressure chambers 31, namely, the parts each of which belongs to (is) one of the piezoelectric ceramic layer 5a, the common electrode 5b and the piezoelectric ceramic layer 5c, and one individual electrode 5d, of the plurality of individual electrodes 5d, corresponding to the parts, form a deforming part 51. Further, in a case that a predetermined driving voltage is applied between the common electrode 5b and the individual electrode 5d, the piezoelectric ceramic layers 5a and 5b in the inside of the deforming part 51 are deformed, thereby applying the discharging pressure to the ink inside the pressure chamber 31.

### Detailed Configuration of Return Throttle Channel

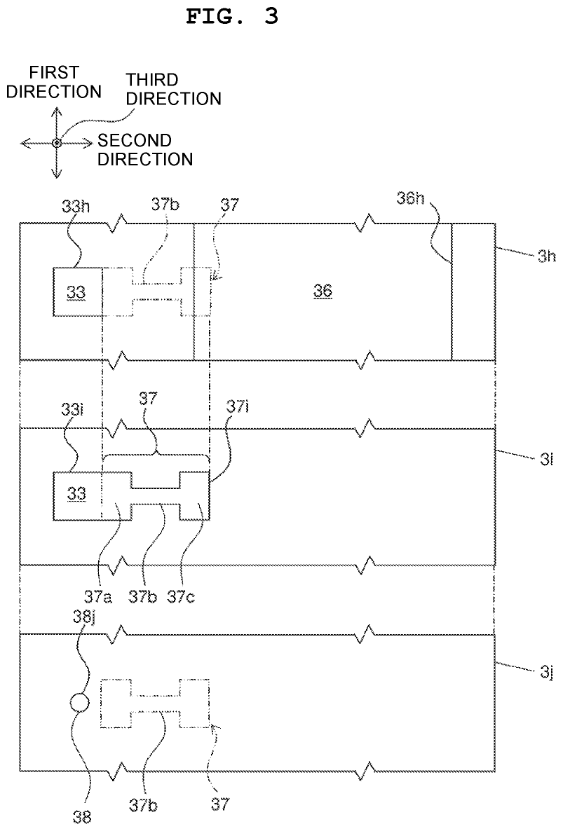

FIG. 3 is a schematic view for explaining the detailed configuration of the return throttle channel 37, depicting partial areas each of which belongs to one of the plates 3h, 3i and 3j and which correspond to one another as seen, in the order of the plates 3h, 3i and 3j, in the third direction from the sheet surface of FIG. 3.

As depicted in FIG. 3, an opening 33h which is a through hole constructing the descender 33 and an opening 36h which is a through port constructing the return manifold 36 are formed in the plate 3h constructing the return manifold plate. An opening 33i which is a through hole constructing the descender 33 and an opening 37i which is a through groove constructing the return throttle channel 37 are formed in the plate 3i constructing the return throttle plate. Further, an opening 38j which is a through hole constructing the nozzle 38 is formed in the plate 3j which constructs the nozzle plate. Note that in FIG. 3, a position of the return throttle channel 37, in a case that the plates 3h to 3j are adhered, is indicated with two-dot chain lines in each of the plates 3h and 3j.

The opening 37i constructing the return throttle channel 37 extends to be substantially parallel to the second direction orthogonal to the first direction in which the return manifold 36 extends. Further, as depicted in FIG. 3, the return throttle channel 37 has an upstream end part 37a, a downstream end part 37c and an intermediate part 37b between the upstream and downstream end parts 37a and 37c in the direction in which the ink flows. Among these parts 37a to 37c, each of the upstream end part 37a and the downstream end part 37c has a size in a channel width (namely, a size in the direction orthogonal to the direction in which the return throttle channel 37 extends) which is greater than that of the intermediate part 37b, as seen from the third direction which is the stacking direction.

In such a manner, in the return throttle channel 37, each of the upstream end part 37a and the downstream end part 37c constructs an enlarged part of which channel cross-sectional area is great in the return throttle channel 37, and the intermediate part 37b constructs a narrow part of which channel cross-sectional area is smaller than that of each of the upstream end part 37a and the downstream end part 37c. Note that the enlarged part and the narrow part are formed to penetrate through the plate 3i by the full etching.

Further, the return throttle channel 37 communicates with the descender 33 via the upstream end part 37a which is one of the enlarged parts. Namely, in the plate 3i, the opening 33i constructing the descender 33 and the opening 37i constructing the return throttle channel 37 are connected via the upstream end part 37a which is the enlarged part of the return throttle channel 37. Note that in the example depicted in FIG. 3, the upstream end part 37a and the opening 33i constructing the descender 33 have a same size in the first direction. Further, the return throttle channel 37 communicates with the return manifold 36 at the downstream end part 37c which constructs the other of the enlarged parts. Namely, in a case that the plates 3h and 3i are adhered to each other, at least a part of the downstream end part 37c of the return throttle channel 37 overlaps with a range of the opening 36h constructing the return manifold 36.

Further, an entirety of openings on the upper side and the lower side of the intermediate part 37b which is the narrow part of the return throttle channel 37 is covered by the plates 3h and 3j which are adhered to the plate 3i. To provide a specific explanation, as depicted in the plate 3h of FIG. 3 with two-dot chain lines, any opening is not formed at a position, in the plate 3h, corresponding to the intermediate part 37b in a case that the plates 3h and 3i are adhered to each other, and the opening on the upper side of the intermediate part 37b is entirely covered by the lower surface of the plate 3h.

Similarly, as depicted in the plate 3j of FIG. 3 with two-dot chain lines, any opening is not formed at a position, in the plate 3j, corresponding to the intermediate part 37b in a case that the plates 3i and 3j are adhered to each other. Accordingly, the opening on the lower side of the intermediate part 37b is entirely covered by upper surface of the plate 3j.

### Technical Effect of Embodiment

As explained above, the liquid ejecting head 10 includes one plate 3i constructing the return throttle plate and at least one plate 3g, 3h (here, two plates) constructing the return manifold plate. Further, the through groove (opening 37i) constructing the return throttle channel 37 is formed in the plate 3i and the through port (36h) constructing the return manifold 36 is formed in the plate 3h; the plate 3i and the plate 3h are directly adhered to each other, thereby allowing the through groove and the through port to communicate with each other.

In this case, since the return throttle channel 37 is formed by, for example, the full etching as the through groove, at least any measuring error in the depth direction does not occur, thereby making it possible to suppress any occurrence of an error in the circulating resistance with respect to the set value. Further, since the plates 3h and 3i are directly adhered to each other, there is no any other plate intervened between the return throttle channel 37 and the return manifold 36, thereby making it possible to reduce the number of the plates and to suppress the increase in the manufacturing cost.

In the foregoing, although the explanation has been given regarding the return throttle channel 37, the aspect of the communicating between the throttle channel and the manifold is similarly constructed also regarding the supply throttle channel 32. Namely, as described above, the channel part 30 of the liquid ejecting head 10 includes one supply throttle plate constructing the supply throttle plate 3b and at least one plate 3c, 3d (here, two plates) constructing the supply manifold plate; a through groove constructing the supply throttle channel 32 is formed in the plate 3b and a through port constructing the supply manifold 34 is formed in each of the plates 3c and 3d. Further, the plate 3b and the plate 3c are directly adhered to each other, thereby allowing the through groove and the through port to communicate with each other.

Accordingly, by forming the supply throttle channel 32 by the full etching as the through groove, at least any measuring error in the depth direction does not occur, thereby making it possible to suppress any occurrence of an error in the circulating resistance with respect to the set value. Further, since the plates 3b and 3c are directly adhered to each other, there is no any other plate intervened between the supply throttle channel 32 and the supply manifold 34, thereby making it possible to reduce the number of the plates and to suppress the increase in the manufacturing cost.

Note that regarding the aspect of communication between the throttle channel and the manifold, although the explanation has been given about the case in which the supply side and the return side are allowed to have a same structure, the present disclosure is not limited to or restricted by this. For example, it is allowable that only the supply side adopts the above-described aspect, or that only the return side adopts the above-described aspect.

Further, the return throttle channel 37 has the narrow part and the enlarged parts, and communicates with the return manifold 36 at the downstream end part 37c constructing one of the enlarged parts. With this, even in such a case that the plate 3h and 3i are adhered to each other and that any positional deviation occurs, it is possible to suppress any affect, due to the positional deviation, to the channel resistance (throttle resistance) in the return throttle channel.

Furthermore, the opening on the upper side and the opening on the lower side of the intermediate part 37b constructing the narrow part in the return throttle channel 37 are both entirely closed by the plates 3h and 3j which are, respectively on the upper side and the lower side with respect to the return throttle channel 37. With this, even in such a case that the plate 3h to 3j are adhered to one another and that any positional deviation occurs, the channel cross-sectional area of the narrow part (intermediate part 37b) of the return throttle channel 37 does not change, thereby making it possible to realize a stable throttle resistance value.

Moreover, in the present embodiment, the thickness size of each of the plate 3b constructing the supply throttle plate and the plate 3i constructing the return throttle plate is made to be not more than 50 μm. With this, in a case of forming each of the throttle channels 32 and 37 by the full etching, it is possible to form a through groove with a small width size, thereby making it possible to easily prepare the throttle channels 32 and 37 having a large throttle resistance.

Note that in the liquid ejecting head 10 according to the present embodiment, in the plates 3h and 3j which are adhered, respectively, to the upper surface and the lower surface of the plate 3i constructing the return throttle plate, an adhesive traversing the opening 37i forming the return throttle channel 37 in the width direction is not present in the part, of each of the plates 3h and 3j, corresponding to the opening 37i forming the return throttle channel 37. Similarly, in the plates 3a and 3c which are adhered, respectively, to the upper surface and the lower surface of the plate 3b constructing the supply throttle plate, an adhesive traversing the opening forming the supply throttle channel 32 in the width direction is not present in the part, of each of the plates 3a and 3c, corresponding to the opening forming the supply throttle channel 32.

With this, it is possible to suppress such a situation that the channel cross-sectional area of each of the throttle channels 32 and 37 might change due to the adhesive, for adhering between the plates, which protrudes or is extruded to each of the throttle channels 32 and 37. As a result, it is possible to realize the stable throttle resistance value in each of the throttle channels 32 and 37.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### Modification

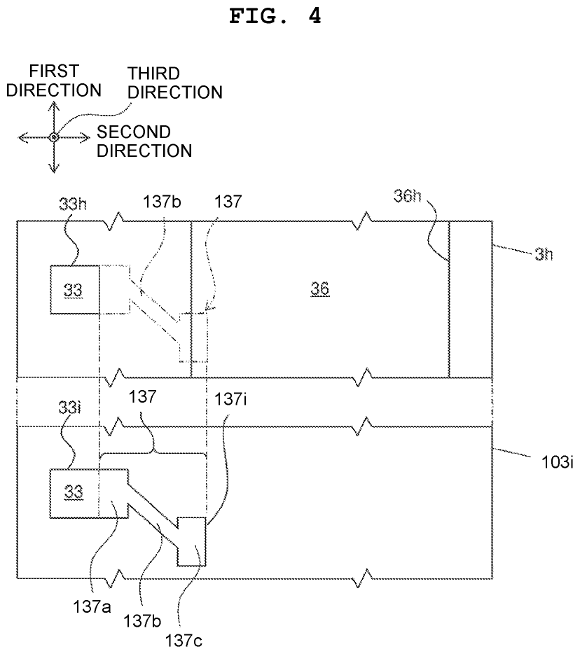

FIG. 4 is a view for explaining a modification of the return throttle channel, and depicting a return throttle plate and a return manifold plate immediately above the return throttle plate. Here, a plate 3h constructing the return manifold plate is same as the plate 3h depicted in FIG. 3. On the other hand, a plate 103i constructing the return throttle plate and depicted in FIG. 4 is different from the plate 3i of FIG. 3.

Namely, in the case of the plate 103i in FIG. 4, a return throttle channel 137 extends while being inclined with respect to the second direction orthogonal to the first direction in which the return manifold 36 extends. Specifically, an opening 137i which is a through groove constructing the return throttle channel 137 has an upstream end part 137a and a downstream end part 137c each of which constructs an enlarged part, and an intermediate part 137b which is located between the upstream end part 137a and the downstream end part 137c and constructing a narrow part. Further, the upstream end part 137a and the downstream end part 137c are positioned to be separated away from each other in the first direction, and a location therebetween is connected by the intermediate part 137b which extends in an inclined direction inclined with respect to both of the first direction and the second direction.

Note that an aspect of the communication between the upstream end part 137a and the descender 33, and an aspect of communication between the downstream end part 137c with the return manifold 36 are same as those explained with reference to FIG. 3.

In the case of the return throttle channel 137 according to such a modification, the intermediate part 137b constructing the narrow part extends in the inclined direction. With this, the intermediate part 137b is allowed to have a long size as compared with the intermediate part 37b of the return throttle channel 37 of FIG. 3. As a result, a large throttle resistance value can be realized stably. Further, even in a case that the distance in the second direction between the descender 33 and the return manifold 36 is short, by providing the configuration wherein the return throttle channel 137 is obliquely extended with respect to the second direction, thereby making it possible to allow the return throttle channel 137 to have a long size and to obtain a large channel resistance.

Note that in the foregoing, although the explanation has been given about the return throttle channel 137 as the modification of the return throttle channel 37, it is also allowable to adopt, also regarding the supply throttle channel 32, a modification having a similar aspect as explained above in which an intermediate part is extended in the inclined direction.

The present disclosure is applicable to a liquid ejecting head configured to discharge a liquid, such as an ink, etc., toward a medium.

What is claimed is:

1. A liquid ejecting head comprising:
a stacked body in which a plurality of plates is stacked, the plurality of plates including a return throttle plate and at least one return manifold plate, wherein
the stacked body includes:
a plurality of individual channels each of which includes a nozzle;
a supply manifold which is configured to supply a liquid to the plurality of individual channels; and
a return manifold configured to allow the liquid which has not been ejected from the nozzle to be returned to the return manifold from the plurality of individual channels,
a supply throttle channel connectable to the supply manifold is located in an upstream end of each of the plurality of individual channels, and a return throttle channel connectable to the return manifold is located in a downstream end of each of the plurality of individual channels,
a through groove constructing the return throttle channel is formed in the return throttle plate, and a through port constructing the return manifold is formed in the at least one return manifold plate, and
the return throttle plate and the at least one return manifold plate are adhered directly to each other so as to allow the through groove and the through port to communicate with each other.

2. The liquid ejecting head according to claim 1, wherein
the plurality of plates further includes a supply throttle plate and at least one supply manifold plate,
a through groove constructing the supply throttle channel is located in the supply throttle plate, and a through port constructing the supply manifold is located in the at least one supply manifold plate, and
the supply throttle plate and the at least one supply manifold plate are adhered directly to each other so as to allow the through groove and the through port to communicate with each other.

3. The liquid ejecting head according to claim 1, wherein
an enlarged part is located in each of an upstream end and a downstream end of the return throttle channel, the enlarge part including a size of a channel width which is greater, as seen from a stacking direction of the plurality of plates, than that of an intermediate part located between the upstream end and the downstream end of the return throttle channel, and
the return throttle channel communicates with the return manifold at the enlarged part.

4. The liquid ejecting head according to claim 3, wherein
an entirety of openings, which correspond to the intermediate part of the return throttle channel, in one surface and the other surface of the return throttle plate is closed by plates, of the plurality of plates, which are adhered, respectively, to the one surface and the other surface of the return throttle plate.

5. The liquid ejecting head according to claim 3, wherein
the enlarged part located in the return throttle channel penetrates through the return throttle plate.

6. The liquid ejecting head according to claim 2, wherein
a thickness of at least one of the return throttle plate and the supply throttle plate is not more than 50 μm.

7. The liquid ejecting head according to claim 2, wherein
the return manifold is elongated in a first direction, and the return throttle channel is inclined with respect to a second direction orthogonal to the first direction.

8. The liquid ejecting head according to claim 2, wherein
the supply manifold is elongated in a first direction, and the supply throttle channel extends is inclined with respect to a second direction orthogonal to the first direction.

9. The liquid ejecting head according to claim 2, wherein
in each of plates, of the plurality of plates, which are adhered, respectively, to one surface and the other surface of the return throttle plate, an adhesive traversing an opening of the through groove constructing the return throttle channel in a width direction is absent in a part, of each of the plates, corresponding to the opening of the through groove.

10. The liquid ejecting head according to claim 2, wherein
in each of plates, of the plurality of plates, which are adhered, respectively, to one surface and the other surface of the supply throttle plate, an adhesive traversing an opening of the through groove constructing the supply throttle channel in a width direction is absent in a part, of each of the plates, corresponding to the opening of the through groove.
